(19) United States
(12) Patent Application Publication
(10) Pub. No.: US 2011/0160938 A1
(43) Pub. Date: Jun. 30, 2011

(54) DEVICE FOR CENTRALIZED MANAGEMENT OF TASKS TO BE CARRIED OUT BY A CREW OF AN AIRCRAFT

(75) Inventors: Christophe CAILLAUD, BLAGNAC (FR); François COULMEAU, SEILH (FR); Gilles FRANCOIS, TOULOUSE (FR); Nicolas MARTY, SAINT SAUVEUR (FR)

(73) Assignee: THALES, NEUILLY-SUR-SEINE (FR)

(21) Appl. No.: 12/980,525

(22) Filed: Dec. 29, 2010

(30) Foreign Application Priority Data
Dec. 30, 2009 (FR) 09 06398

(51) Int. Cl. G05D 1/00

(52) U.S. Cl. 701/3

(57) ABSTRACT

The present invention relates to a device for centralized management of tasks to be carried out by a crew of an aircraft. A task to be carried out includes a triggering condition and an instruction to be executed. The device includes a man-machine interface for managing tasks by the crew, a module for creating, modifying, deleting tasks, a module for triggering a task, a module for acknowledging a task performed, a module for executing a task, and an interface with systems of the aircraft which are able to create and to execute tasks. The invention applies to the piloting tasks carried out by the pilots of an aircraft.

### CROSS-REFERENCE TO RELATED APPLICATION

This application claims priority to foreign French patent application No. FR 09 06398, filed on Dec. 30, 2009, the disclosure of which is incorporated by reference in its entirety.

### FIELD OF THE INVENTION

The present invention relates to a device for managing tasks to be carried out by a crew of an aircraft. More particularly, the invention relates to the piloting tasks carried out by the pilots of an aircraft. The invention can be applied to flight management systems of an aircraft, such as systems for aiding navigation, centralized systems of in-flight alerts, monitoring systems, communication systems, and man-machine interfaces with the systems.

### BACKGROUND OF THE INVENTION

The increase in air traffic is giving rise to an increase in the workload of aircraft pilots. Notably, the crew must cope with numerous tasks to be accomplished in the course of a flight. Conversely, the number of crew members is tending to decrease. It thus becomes crucial to relieve the flight personnel of certain simple tasks in favour of complex tasks, which may only be performed by a crew member. Moreover, it is necessary that the crew members devote themselves by priority to tasks that may involve the material integrity of the aircraft and physical integrity of the passengers aboard the aircraft.

Certain systems aboard aircraft offer automation of tasks or assistance with the implementation of certain tasks. For example, certain systems automate routine and simple tasks. Other systems, in respect of cases of system alarms or faults, provide a function aiding the implementation of tasks for resolving the alarms or faults: these systems offer lists of checks comprising a set of tasks to be accomplished.

Some systems also make it possible to manage instructions that may originate from an air traffic controller, from an airline.

Yet other systems make it possible to manage radio frequencies, voice frequencies, radionavigation beacon frequencies, by way of a dedicated man-machine interface.

Each of these flight management systems has a particular use, specific to its functionalities. Thus each system has its own procedures, its own man-machine interfaces. The crew must therefore pass incessantly from one man-machine interface to another to accomplish the various task-related procedures.

### SUMMARY OF THE INVENTION

Embodiments of the invention remedy at least the aforementioned drawbacks. The invention includes a device for managing tasks of a crew of an aircraft. A task includes at least a triggering condition, and an instruction to be executed.

The device includes at least:
a man-machine interface for managing tasks by the crew;
a module for creating, modifying, deleting tasks;
a module for triggering a task;
a module for acknowledging a task performed;
a module for executing a task;
an interface with systems of the aircraft which are able to create, to execute tasks.

The man-machine interface can advantageously be adapted for task creation, modification, deletion by the crew.

In another embodiment, the module for creating, modifying, deleting tasks may be adapted for task creation, deletion, modification on receipt of information originating from the interface with the aircraft's systems.

The device can in a particular embodiment comprise a module for acknowledging a task recovering information on the state of progress of processing of the task by way of the interface with the aircraft's systems.

Advantageously, the interface with the aircraft's systems can recover:
information for the creation of tasks;
task processing state information;
states of variables used as condition for triggering a task;
   originating from the aircraft's systems. The interface with the aircraft's systems can also transmit orders for executing tasks to the aircraft's systems.

The device can comprise a module for scheduling tasks, the said tasks being for example managed in the form of a list.

The device can include a task triggering module verifying the conditions for triggering the tasks on receipt of states of variables used as task triggering condition.

In an embodiment, the module for executing a task can transmit, by way of the interface with the aircraft's systems, an order for executing a task to the aircraft's said systems.

The display of a task to be executed can advantageously be performed on a man-machine interface dedicated to the system making it possible to execute the task.

In another embodiment:
the module for managing a task may be integrated into a Flight Management System FMS;
the modules for scheduling tasks, for task acknowledgement, for task triggering may be integrated into a centralized in-flight alert system FWS, the acronym standing for the expression Flight Warning System;
the man-machine interface may be distributed between the FMS and the FWS.

In another embodiment:
the man-machine interface, the module for managing a task may be integrated into a Cockpit Display System CDS;
the modules for scheduling the tasks, for acknowledging a task, for triggering a task, the module for executing a task may be integrated into a centralized in-flight alert system FWS, the acronym standing for the expression Flight Warning System.

The invention provides simplified integration of new tasks that are to be accomplished by a crew of an aircraft.

### BRIEF DESCRIPTION OF THE DRAWINGS

Other characteristics and advantages of the invention will become readily apparent with the aid of the description which follows, given by way of nonlimiting illustration, and presented with regard to the appended drawings, which represent:

FIG. 1: a simplified flowchart of the device according to the invention;

FIG. 2: a first possible architecture embodying the device according to the invention; and

FIG. 3: a second possible architecture embodying the device according to the invention.

### DETAILED DESCRIPTION

The acronyms used in the present patent application are listed and explained in the following table:

| Acronym | Expression | Meaning |
|---|---|---|
| AOC | Air Operation Centre | |
| ATC | Air Traffic Control | |
| CDS | Cockpit Display System | |
| CMU | Communications | |
| | Management Unit | |
| CUNIMB | Cumulonimbus | |
| ECAM | Electronic Centralized Aircraft | |
| | Monitor | |
| FCU | Flight Control Unit | |
| FL | Flight Level | |
| FPC | Flight Plan Check | |
| FMS | Flight Management System | |
| FWS | Flight Warning System | Centralized in-flight alert |
| | | system |
| MMI | Man-Machine Interface | |
| ND | Navigation Display | Navigation screen |
| RMS | Radio Management System | |
| TAWS | Terrain Avoidance Warning | Alarm system for terrain |
| | System | avoidance |
| TCAS | Traffic Alert and Collision | |
| | Avoidance System | |
| UTC | Universal Time Coordinated | |
| WxR | Weather Radar | |

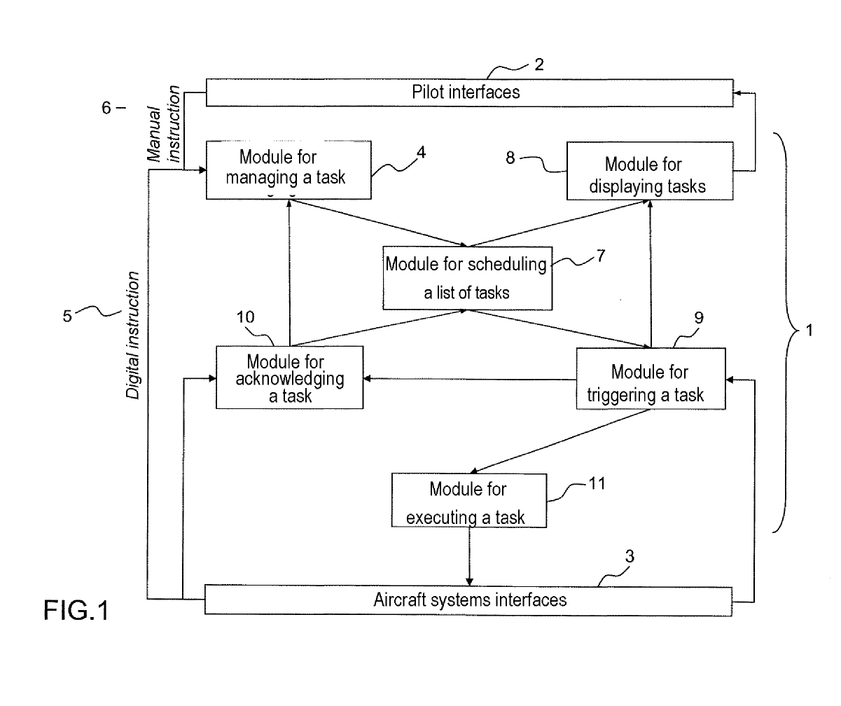

FIG. 1 represents various functional blocks of the device for managing tasks 1 according to the invention. The device according to the invention is applied to the management of tasks to be accomplished by the personnel of the flight deck of an aircraft. Hereinafter, the personnel of the flight deck is simply designated by: the pilot. The device according to the invention makes it possible for example to manage the following tasks:
conducting of check-lists related to faults with systems of the aircraft;
conducting of check-lists related to alerts originating for example from a weather radar, from a system for checking the flight plan, from a traffic alert and collision avoidance system;
usual tasks carried out by the crew during the flight, for example a change of frequency in respect of communications with the ground;
navigation-related monitoring tasks such as manoeuvres for maintaining a separation between aircraft;
implementation of instructions originating from an ATC or from an AOC and received by the aircraft through an FMS system.

To ensure centralized management of the tasks to be accomplished, the device according to the invention can comprise two types of interface:
a first type of interface 2 groups together pilot interfaces: the pilot interfaces 2 are man-machine interfaces, allowing notably the pilot to interact with one or more flight management systems. The pilot interfaces 2 allow the pilot to enter data taken into account by a system. The pilot interfaces 2 also allow the flight management systems to display information destined for the pilot of the aircraft. An example of a pilot interface 2 is the ECAM;
a second type of interface 3 groups together interfaces with systems aboard the aircraft such as flight management systems for example: an FMS, a TAWS, a WxR.

The first type of interface 2 allows the pilot to interact with the device 1 according to the invention. For example, a pilot interface can allow the pilot to enter a task that he must accomplish. A pilot may, for example, be led to enter a task manually subsequent to receiving an audio order originating from a ground control centre or from the airline. The pilot interfaces 2 also make it possible to display the tasks to be carried out and also the various steps necessary for accomplishing these tasks. Other functionalities and interactions of the pilot interfaces 2 with the device according to the invention are described subsequently.

The second type of interface 3 allows the device according to the invention notably to receive information on tasks to be accomplished by the pilot, information for deducing a state of progress in the processing of the tasks. The second type of interface 3 also allows the device according to the invention to trigger a carrying out of tasks, of procedures carried out by the flight management systems. Other functionalities and interactions of the system interfaces with the device according to the invention are explained subsequently.

The device according to the invention comprises a first functional module for managing a task 4. The first module 4 is a module for creating, deleting, modifying a task. The module for managing a task can create a task on receipt:
of a digital instruction 5 originating from a system interface 3;
of a manual instruction 6 originating from a pilot interface 2.

The digital instruction 6 and also the manual instruction 5 can comprise information making it possible to create a task.

A task may be characterized by:
a time associated with the task;
a value, a range of values for a flight variable, such as a speed, an altitude, a height relative to the ground, a distance relative to another aircraft, a flight phase, an event;
an instruction to be executed.

A time associated with a task may be: a time at which the task must be executed; a time onwards of which the task must be executed; a time at which the task must be terminated; a time at which the task is created, by default. Other conditions for taking the time into account may be defined. The time allows notably a scheduling of the various tasks created. When the time is reached, the device according to the invention displays for example the instruction, accomplishes the instruction when the latter can be carried out automatically, checks another condition such as a value of a flight variable.

A flight variable may originate from aircraft systems. A flight variable may also be a particular flight phase such as a summit point of a climb phase, a floor point of a descent phase.

An instruction may be a procedure to be carried out by the crew, a display of an item of information on a pilot interface 2.

For example, a manual instruction 6 can notably comprise the following information:
a time associated with the task to be created;
a position, for example a waypoint on a flight plan;
an altitude value, speed value;
a major event of the flight, for example:
   a terrain proximity, detected by the terrain proximity monitoring system (TAWS), so as to trigger procedures of flight plan check type;
   an aircraft proximity, detected by the in-flight anticollision system (TCAS), so as to trigger traffic separation procedures;
   a particular flight phase.
a possible instruction, which may be a free text to be displayed, an alert.

On receipt of an instruction 5, 6, the module for managing a task 4 creates a task object. The task object can comprise the following attributes:
a time, which can for example be a predicted time corresponding to an event, when the module has information relating to the flight plan followed by the aircraft;
a parameter on which the task is triggered;
an instruction associated with the task.

A task object can furthermore comprise a feature characterizing its degree of importance, as well as a parameter indicating the origin of the task. This information may be useful to the pilot during the execution of the task.

The time is not necessarily entered; in a manual instruction 6, for example, a manual instruction can in place of the time specify a place for inserting the task created between two existing tasks. For example it is possible to insert the following free text: “CONTACT KZAK CTRL 20 MIN BEF APP” before a task originating from a system instruction such as: “12:35 UTC: APPROACH”, the said task originating from a system instruction being related to a predicted approach time for example computed by the FMS system.

The task created can thereafter be modified, for example by a manual instruction.

The task created can also be deleted either on manual instruction, or when the task is accomplished, or on instruction from a flight management system.

A second module 7 of the device according to the invention may be a module for scheduling tasks 7. The tasks scheduling module 7 manages an ordered list of tasks. That is to say the scheduling module 7 inserts the tasks created by the module for managing a task into an ordered task list. The scheduling module also deletes tasks from the ordered list on deletion of a task by the module for managing a task 4.

The module for scheduling tasks 7 can rank the tasks in chronological order according to the predicted time for example. When a first task does not comprise any predicted time but a reference to a second task, such as before or after the second task, the module for scheduling tasks 7 places, in the list of tasks, the first task as a function of the reference to the second task.

The scheduling module 7 also performs a regular update of the current time as a function of the flight plan, so as to be able to reschedule the list.

A third module 8 is a task display module. The task display module 8 displays notably on a pilot interface the list of the tasks ordered by the scheduling module 7. The display module also displays on a pilot interface a task when the condition for triggering the task is fulfilled. The task displayed is therefore a task to be accomplished by the pilot. This task may be displayed as a function of its context of execution. Indeed, it is possible, depending on the instructions to be implemented, to choose to display the task on a pilot interface dedicated to a flight management system making it possible to accomplish the task.

A fourth module 9 may be a module for triggering a task 9. The module for triggering a task 9 performs a monitoring of the tasks of the list of tasks and notably of their triggering condition. Thus it collects information for example regarding the state of the aircraft, the progress of the flight plan, which information is communicated to it by the aircraft's systems, notably by the flight management system. The information originating from the aircraft's systems are transmitted to the module for triggering a task 9 by the interfaces with the aircraft systems. When the task triggering module 9 detects that a condition for activating a task is fulfilled, the task is transmitted for display to the task display module 8. A condition for triggering a task may be reached for example when the triggering parameter is satisfied; the task display module 8 then displays the task on a pilot interface 2 adapted for the processing and/or for the viewing of the task 8. For example if the parameter for triggering the task is an altitude value, then when the altitude of the aircraft reaches the altitude value, the task is triggered by the task triggering module 9. When several tasks may be triggered, the triggering module 9 for a task can choose one of the tasks as a function of a degree of priority which may be attached to the task.

A fifth module 10 is a module for acknowledging a task. The module for acknowledging a task 10 recovers each task triggered by the module for triggering a task 9 and monitors the execution of the task. The monitoring of the execution of a task is performed by checking information regarding the progress of the processing of the current task by the flight management systems. The information regarding the progress of the processing of the current task is communicated to the module for acknowledging a task 10 by the interfaces with the aircraft systems 3. Once a task has been acknowledged, it is deleted by the module for managing a task 4. The deleted task is deleted from the task list managed by the module for scheduling the tasks 7. Next the list of tasks is rescheduled by the module for scheduling the tasks. Finally the task triggering module 10 prompts the pilot with another task to be carried out for which the triggering conditions are fulfilled.

A sixth module 11 is a module for executing the triggered task. A task triggered by the task triggering module 9 is processed by the module for executing the task 11. The module for executing the task 11 handles a part of the carrying out of the instruction associated with the task. When the execution of the task can be automated, the execution module transmits the task to be executed to one or more systems responsible for carrying out the task, by way of the interface of the system 3. For example, if the task to be executed is worded in the following manner: “11:50 UTC: ACTIVE CUNIMB AHEAD”, meaning: an active cumulonimbus will lie on the route of the aircraft at eleven hours fifty UTC, the module for executing a task 11 then requests the weather radar to automatically display a weather map on the ND at eleven hours fifty UTC. Another example may be a task arising from a digital instruction 5 originating from an ATC of the following type: “AT AFRIC CLIMB TO FL340”, meaning at the point “AFRIC” proceed to an altitude of 340FL. In this case, the module for executing a task 11 requests the FCU to preselect the altitude 340FL when the aircraft proceeds past the point “AFRIC”.

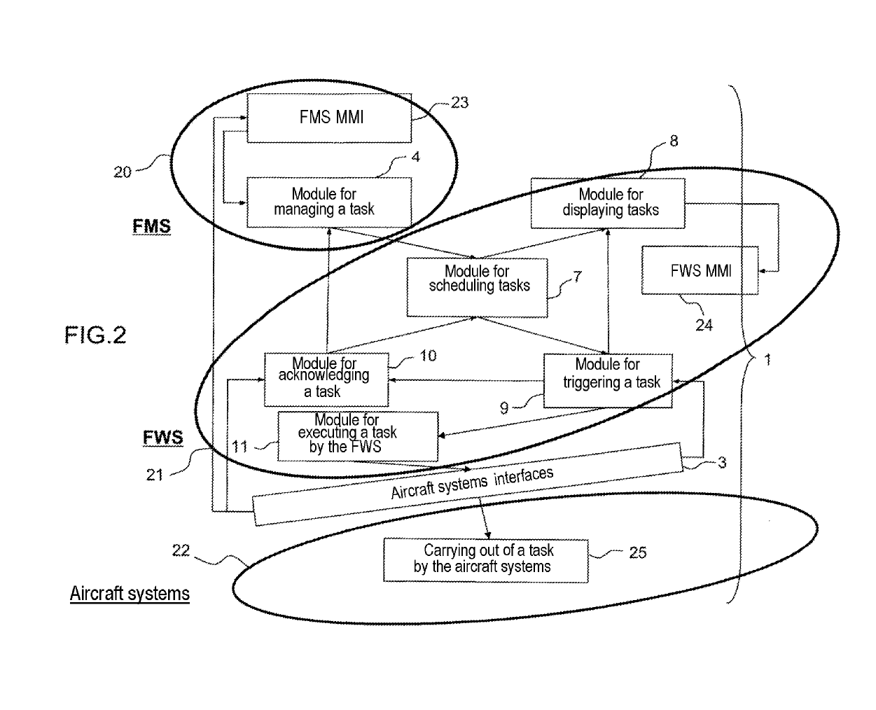

FIG. 2 represents a first possible architecture of the device 1 according to the invention, such as represented in FIG. 1. In an exemplary embodiment, the device according to the invention may be integrated into existing flight management systems aboard the aircraft. In the example represented in FIG. 2, the functional modules 2, 3, 4, 7, 8, 9, 10, 11 of the device 1 according to the invention are apportioned between the following systems:
a first FMS system 20;
a first FWS system 21;
one or more aircraft systems 22.

For example, the module for managing a task 4 can be integrated into the first FMS system 20. The first FMS system knowing the flight plans, the computation of the predicted time can thus be performed while taking account of the flight plan followed by the aircraft. The first FMS system 20 comprises its own pilot interface: an FMS MMI 23.

The first FWS system includes the following functional modules:
the task display module 8;
the module for scheduling tasks 7;
the module for acknowledging a task 10;
the module for triggering a task 9;
the module for executing a task 11.

The first FWS system also includes its own pilot interface: an FWS MMI 23. Advantageously, the first FWS system 21 already comprises a centralized alert management function. It also comprises management of tasks related to these alerts; advantageously it is thus possible to use the mechanisms existing in the first FWS 21 to manage any type of task, and notably tasks originating from the first FMS system 20.

The module for executing a task 11 selects one or more of the aircraft systems 22 adapted for carrying out the task. The module for executing a task 11 also formulates commands to be transmitted to the aircraft systems 22 by way of the aircraft systems interface 3 so that they carry out the task. On receipt of the commands, the aircraft systems 22 carry out the task 25.

For example, if the task is “11:50 UTC: ACTIVE CUNIMB AHEAD” the module for executing a task 11 of the FWS 21 determines that, when a cumulonimbus is forecast, it is necessary to display the information originating from the radar on the ND. The module for executing a task 11 therefore formulates a command to display the radar information on the ND and then transmits this command to the display system ND by way of the aircraft systems interfaces 3. The aircraft system 22 concerned, that is to say the ND, carries out the task and presents the radar information to the pilot.

The pilot interface function 2 is here distributed between the first FMS system 20 and the first FWS system 21. This advantageously makes it possible to use existing MMIs to implement the device according to the invention at lower cost.

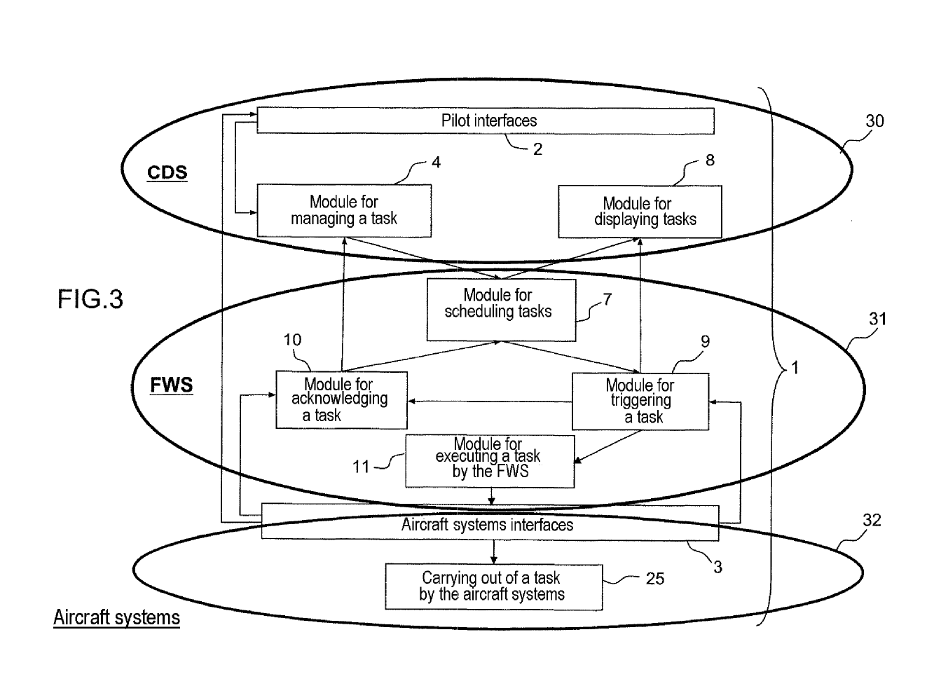

FIG. 3 represents a second possible architecture for implementing the device 1 according to the invention.

In this second exemplary possible architecture, the various functional modules of the device according to the invention are implemented by existing flight management systems. Notably:
a first CDS system 30 can implement the modules for: managing a task 4, for displaying tasks 8, the pilot interfaces 8;
a second FWS system 31 can implement the modules for scheduling tasks 7, for acknowledging a task 10, for triggering a task 9, the module for executing a task 11, and can comprise interfaces with the aircraft systems 3.

Second aircraft systems 32 can implement the commands formulated by the module for executing a task 11.

For example, if the task is “11:50 UTC: ACTIVE CUNIMB AHEAD” the module for executing a task 11 of the FWS 31 determines that, when a cumulonimbus is forecast, it is necessary to display the information originating from the radar on the CDS 30. The module for executing a task 11 therefore formulates a command to display the radar information on the CDS 30 and then transmits this command to the CDS display system by way of the aircraft systems interfaces 30. The CDS 32 carries out the task and presents the radar information to the pilot. Advantageously, this architecture exhibits a centralized pilot MMI, the first CDS system 30, facilitating the interaction of the pilot with the device according to the invention. Indeed, the interface with the management of all the tasks of the aircraft systems is centralized. This therefore offers simplicity of use for the pilot.

The present invention ensures optimized management of tasks. Optimized management such as this allows:
all the tasks to be carried out by a crew may be taken into account by the device according to the invention;
a reduction in the workload of the crew generally, the automatable tasks no longer being the responsibility of the crew, and the management of the crew's various tasks being carried out in a quasi automatic manner by the device according to the invention;
better homogeneity of the use of the systems whose man-machine interfaces are situated in the cockpit by displaying the tasks to be carried out on the MMIs of the systems concerned with the tasks to be carried out.

What is claimed is:

1. A device for managing tasks of a crew of an aircraft, the tasks comprising a triggering condition and an instruction to be executed, said device comprising:
a man-machine interface for managing tasks by the crew;
a module for creating, modifying, and deleting tasks;
a module for triggering a task;
a module for acknowledging a task performed;
a module for executing a task; and
an interface with systems of the aircraft which are able to create and to execute tasks.

2. The device according to claim 1, wherein the man-machine interface is adapted for task creation, modification, and deletion by the crew.

3. The device according to claim 1, wherein the module for creating, modifying, and deleting tasks is adapted for task creation, deletion, modification on receipt of information originating from the interface with the aircraft's systems.

4. The device according to claim 1, further comprising a module for acknowledging a task recovering information on the state of progress of processing of the task by way of the interface with the aircraft's systems.

5. The device according to claim 1, wherein the interface with the aircraft's systems recovers:
information for the creation of tasks;
task processing state information; and
states of variables used as condition for triggering a task,
originating from the aircraft's systems, and the interface transmits orders for executing tasks to the aircraft's systems.

6. The device according to claim 1, further comprising a module for scheduling tasks, said scheduled tasks being managed in the form of a list.

7. The device according to claim 1, further comprising a task triggering module for verifying the conditions for triggering the tasks on receipt of states of variables used as task triggering condition.

8. The device according to claim 1, wherein the module for executing a task transmits, by way of the interface with the aircraft's systems, an order for executing a task to the aircraft's systems.

9. The device according to claim 1, wherein the display of a task to be executed is performed on a man-machine interface dedicated to the system making it possible to execute the task.

10. The device according to claim 8, wherein
the module for managing a task is integrated into a flight management system FMS,
the modules for scheduling tasks, for task acknowledgement, for task triggering are integrated into a centralized in-flight alert system comprising a flight warning system FWS, and
the man-machine interface is distributed between the FMS and the FWS.

11. The device according to claim 8, wherein
the man-machine interface, the module for managing a task are integrated into a cockpit display system CDS, and
the modules for scheduling tasks, for task acknowledgement, for task triggering are integrated into a centralized in-flight alert system comprising a flight warning system FWS.
